(19) United States
(12) Patent Application Publication
(10) Pub. No.: US 2019/0285431 A1
(43) Pub. Date: Sep. 19, 2019

(54) INFORMATION PROVISION SYSTEM, INFORMATION PROVISION METHOD, AND NON-TRANSITORY COMPUTER-READABLE MEDIUM

(71) Applicant: HONDA MOTOR CO., LTD., Tokyo (JP)

(72) Inventor: Jun OHASHI, Wako-shi (JP)

(21) Appl. No.: 16/282,849

(22) Filed: Feb. 22, 2019

(30) Foreign Application Priority Data
Mar. 19, 2018 (JP) 2018-051144

(51) Int. Cl. G01C 21/36; G01C 21/34; G06K 9/00

(52) U.S. Cl. CPC G01C 21/3697; G06K 9/00832; G01C 21/3484

(57) ABSTRACT

An information provision system with a provision unit capable of providing information to a plurality of persons in a perceptible manner, comprises: a selection unit that selects the information provided by the provision unit by using selection information associated with a person to be provided with the information; and a determination unit that determines whether the information provided by the provision unit is perceived by the plurality of persons, wherein according to a determination, by the determination unit, that the plurality of persons perceive the information provided by the provision unit, the selection unit selects the information provided by the provision unit by using, as the selection information, information of a superordinate concept of the selection information that is used when it is determined that the plurality of persons do not perceive the information provided by the provision unit.

### CROSS-REFERENCE TO RELATED APPLICATION(S)

This application claims priority to and the benefit of Japanese Patent Application No. 2018-051144 filed on Mar. 19, 2018, the entire disclosure of which is incorporated herein by reference.

### BACKGROUND OF THE INVENTION

### Field of the Invention

The present invention relates to an information provision system, an information provision method, and a non-transitory computer-readable medium; and in particular, an information provision technique.

### Description of the Related Art

In the related art, a function of providing, in a given space such as the interior of an automobile, information to a user present in the given space is known. The information provided by such a function is, for example, route information for a travelling automobile, other information directly or indirectly related to the route, and the like (e.g. Japanese Patent Laid-Open No. 2016-122228).

Examples of such information provided to the user present in the above-mentioned space include information that is collected and customized in accordance with the user's taste (preference). In this case, in some situations it is not appropriate to directly provide the information selected based on a preference and an attribute of a particular user when considering the preference of the information for the user, the relationship between the persons, and the like in a case that a plurality of persons are present in a certain space.

Japanese Patent Laid-Open No. 2016-122228 discloses that output information other than route guide is output when no fellow passenger is present in the interior of a vehicle. In Japanese Patent Laid-Open No. 2016-122228, whether information output is performed is determined based on presence/absence of the fellow passenger; however, the content of the information that should be provided is not taken into consideration.

### SUMMARY OF THE INVENTION

In the present invention, information is appropriately provided by selecting information to be provided in accordance with the presence of a plurality of persons who receive the information.

An information provision system according to an embodiment of the present invention is provided with a provision unit capable of providing information to a plurality of persons in a perceptible manner, the information provision system including: a selection unit configured to select the information provided by the provision unit by using selection information associated with a person to be provided with the information; and a determination unit configured to determine whether the information provided by the provision unit is perceived by the plurality of persons, wherein in accordance with a determination, by the determination unit, that the plurality of persons perceive the information provided by the provision unit, the selection unit selects the information provided by the provision unit by using, as the selection information, information of a superordinate concept of the selection information that is used when it is determined that the plurality of persons do not perceive the information provided by the provision unit.

An information provision method according to another embodiment of the present invention uses a provision unit capable of providing information to a plurality of persons in a perceptible manner, the method including: selecting the information provided by the provision unit by using selection information associated with a person to be provided with the information; and determining whether the information provided by the provision unit is perceived by the plurality of persons, wherein the selecting includes, according to a determination, in the determining, that the plurality of persons perceive the information provided by the provision unit, selecting the information provided by the provision unit by using, as the selection information, information of a superordinate concept of the selection information that is used when it is determined that the plurality of persons do not perceive the information provided by the provision unit.

A non-transitory computer-readable medium according to another embodiment of the present invention stores a program for causing a computer to function as a selection unit configured to select information provided by a provision unit by using selection information associated with a person to be provided with the information, the provision unit being capable of providing the information to a plurality of persons in a perceptible manner; and a determination unit configured to determine whether the information provided by the provision unit is perceived by the plurality of persons, wherein according to a determination, by the determination unit, that the plurality of persons perceive the information provided by the provision unit, the selection unit selects the information provided by the provision unit by using, as selection information, information of a superordinate concept of the selection information that is used when it is determined that the plurality of persons do not perceive the information provided by the provision unit.

According to the present invention, information can be appropriately provided by selecting information to be provided in accordance with the presence of a plurality of persons who receive the information.

Further features of the present invention will become apparent from the following description of exemplary embodiments (with reference to the attached drawings).

### BRIEF DESCRIPTION OF THE DRAWINGS

FIG. 1 illustrates an exemplary schematic configuration of a system according to an embodiment of the present invention.

FIG. 2 illustrates an exemplary hardware configuration of an information processing apparatus according to the present invention.

FIG. 3 illustrates an exemplary software configuration of an information provision apparatus according to the present invention.

FIG. 4 is a drawing for describing superordinate and subordinate concepts of information according to the present invention.

FIG. 5 is a drawing for describing a relationship between persons according to the present invention.

FIG. 6 is a flowchart of a process according to the present invention.

### DESCRIPTION OF THE EMBODIMENTS

An embodiment of the present invention is described below with reference to the drawings. Note that the configurations and the like described below are merely examples, and the present invention is not limited to the configurations and the like described below.

### First Embodiment

### System Configuration

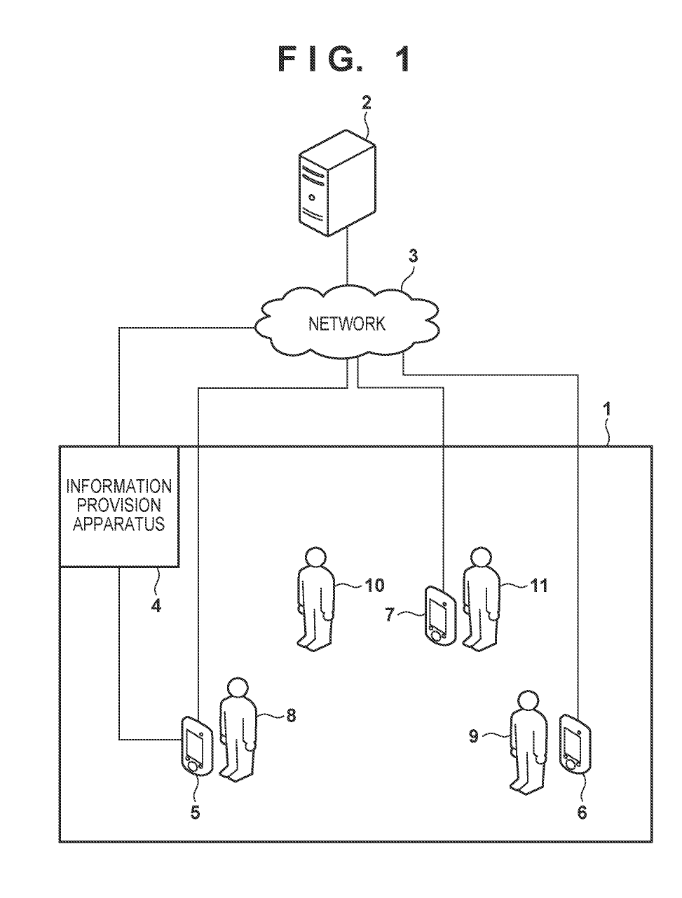

FIG. 1 illustrates an exemplary schematic configuration of a system according to the present embodiment. An information provision apparatus 4 is disposed in a space 1. The information provision apparatus 4 is communicatively connected with an external apparatus 2 via a network 3. In addition, four persons, 8 to 11, are present in the space 1. The persons 8, 9 and 11 carry mobile terminals 5, 6 and 7, respectively. The mobile terminals 5, 6 and 7 can communicate with the external apparatus 2 via the network 3. In addition, the mobile terminal 5 is communicatively connected with the information provision apparatus 4.

The space 1 is, for example, an interior of a vehicle that can accommodate a plurality of passengers. Note that the space 1 is not limited to this and may be other spaces. While four persons are present in the space 1 here, it suffices that two or more persons can be present.

The external apparatus 2 functions as a server that performs various processes in response to a request from the information provision apparatus 4 and/or the mobile terminals 5 to 7, for example. While only one external apparatus 2 is provided here to simplify the description, a plurality of external apparatuses 2 may be provided in accordance with the service to be provided.

The information provision apparatus 4 functions as an information processing apparatus and includes a part for outputting information such as a display unit and a speaker, for example. The communication method between the information provision apparatus 4 and the network 3 is not limited. Output apparatuses such as a display unit and a speaker may be configured to be provided external to the information provision apparatus 4 in the space 1.

Examples of the mobile terminals 5 to 7 include a mobile phone, a smartphone, a mobile terminal, and the like. The mobile terminals 5 to 7 include a communication unit for communication with external apparatuses, a display unit for displaying a variety of information, and an input unit for receiving user's operation. Note that the communication method between the mobile terminals 5 to 7 and the network 3 may be, but not limited to, a phone circuit or a connection circuit for data communication. In addition, the connection method between the mobile terminal 5 and the information provision apparatus 4 may be a wired connection or a wireless connection, and for example, a near-field wireless communication such as Wi-Fi (registered trademark) and Bluetooth (registered trademark) may be used. While only the mobile terminal 5 is connected with the information provision apparatus 4 in the example configuration illustrated in FIG. 1, other mobile terminals such as a mobile terminal 6 and a mobile terminal 7 may be connected with the information provision apparatus 4.

While the network 3 includes, for example, the Internet, the communication standard, whether the connection is wired or wireless and the like are not limited.

While the space 1 is a vehicle interior in the exemplary system configuration illustrated in FIG. 1, the configuration is not limited to this. In addition, while processes are performed by the information provision apparatus 4 provided in the space 1 here, the mobile terminal 5 may be configured to function as an information provision apparatus and is used in the interior of a vehicle, for example. In this case, the function as the information provision apparatus may be provided by an application software (not illustrated in the drawing) installed in the mobile terminal 5.

Exemplary Hardware Configuration

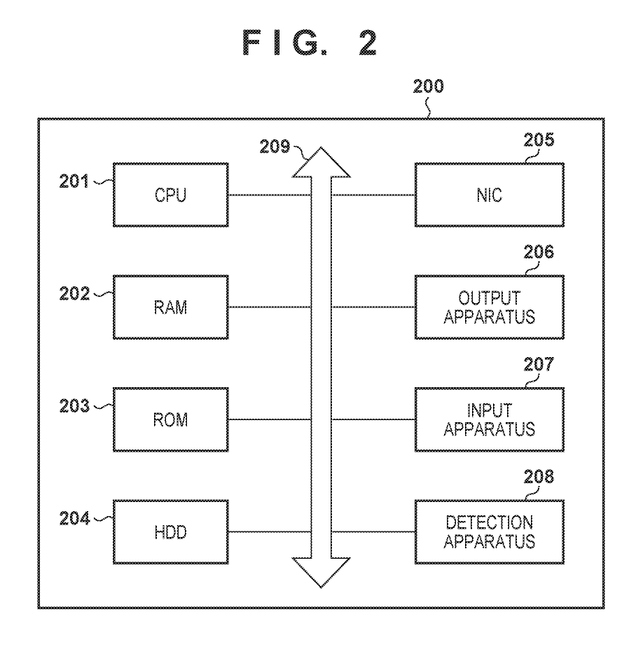

FIG. 2 illustrates an exemplary hardware configuration of an information processing apparatus that functions as the information provision apparatus 4 according to the present embodiment. Note that the following description will be made on the assumption that a mobile terminal according to the present embodiment also has a function of a similar kind.

An information processing apparatus 200 includes a CPU 201, a Random-Access Memory (RAM) 202, a Read-Only Memory (ROM) 203, a Hard Disk Drive (HDD) 204, a Network Interface Card (NIC) 205, an output apparatus 206, an input apparatus 207, and a detection apparatus 208. The components are communicatively connected with each other via an internal bus 209. The CPU 201 manages the control of the entire process of the information processing apparatus 200. The RAM 202 is a volatile storage area and is used as a work memory and the like. The ROM 203 is a nonvolatile storage area and holds various programs and data. The HDD 204 is a nonvolatile storage area and holds various data. The NIC 205 manages communications with external apparatuses via an external network (not illustrated in the drawing) and transmits and/or receives various data. In the communication method described here, whether the communication is wired or wireless and the communication method are not limited, and combinations thereof may be adopted. The output apparatus 206 outputs various data to external devices. The output apparatus 206 may include a display device such as a display and/or a speaker that outputs sound. The input apparatus 207 receives input and instructions from the outside. The detection apparatus 208 includes, for example, a sensor or the like that is used for detecting the user's presence in the space 1 and/or for acquiring feature information of each user. As the detection apparatus 208, a plurality of apparatuses such as a temperature sensor, a weight sensor, a camera and a microphone may be used, for example.

Software Configuration

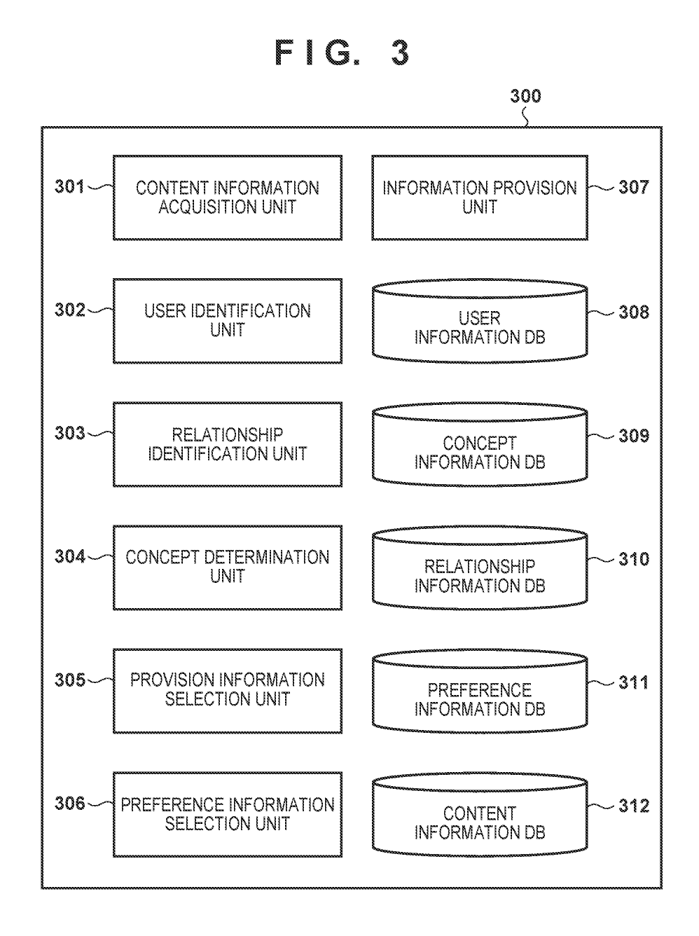

FIG. 3 illustrates an exemplary software configuration of an information provision system 300 provided in the information provision apparatus 4 according to the present embodiment. The information provision system 300 includes a content information acquisition unit 301, a user identification unit 302, a relationship identification unit 303, a concept determination unit 304, a provision information selection unit 305, a preference information selection unit 306, and an information provision unit 307. Further, the information provision apparatus 4 includes a user information DB 308, a concept information DB 309, a relationship information DB 310, a preference information DB 311, and a content information DB 312.

The content information acquisition unit 301 acquires, from the external apparatus 2 (e.g. content server) and the like, information (content information) to be provided. The content information thus acquired is held and managed in the content information DB 312. Note that content information may be configured to be held in advance and be updated as necessary. The user identification unit 302 identifies the user who is present in the space 1 on the basis of information acquired from the detection apparatus 208, for example. Information about users is managed in the user information DB 308. The relationship identification unit 303 identifies the relationship between the persons present in the space 1. The definition of the relationship is defined in advance and held in the relationship information DB 310.

The concept determination unit 304 determines the level of the concept used for selecting the content in a relationship of superordinate and subordinate concepts according to the present embodiment. The superordinate and subordinate concepts according to the present embodiment are described later. The provision information selection unit 305 selects content information to be provided from the held content information on the basis of the concept determined by the concept determination unit 304. The preference information selection unit 306 acquires information about a preference of the user present in the space 1 and accumulates the information in the preference information DB 311. In addition, the preference information selection unit 306 selects, from the preference information accumulated in the preference information DB 311, preference information for use in sorting the content information to be provided. Content information to be provided is selected by the provision information selection unit 305 on the basis of the preference information selected by the preference information selection unit 306 and the concept level information determined by the concept determination unit 304. The information provision unit 307 provides the content information selected by the provision information selection unit 305.

The user information DB 308 is a database for managing information of a user who is present in the space 1. In the example illustrated in FIG. 1, at least information of a user (here, the person 8 carrying the mobile terminal 5) who connects a mobile terminal to the information provision apparatus 4 is managed. The concept information DB 309 is a database for holding information defining superordinate and subordinate concepts for information (or category). The superordinate and subordinate concepts may not be fixed and may be changed in accordance with statistical data and the like, and other concepts may be added. The relationship information DB 310 holds relationship information defining a relationship between persons. The relationship information also defines a determination criterion for determining a relationship between persons.

The preference information DB 311 is a database that holds information about the user's preferences. The preferences may be configured to be classified in advance, or other preferences may be configured to be added. Preferences suitable for each user may be configured to be statistically determined in accordance with the information accessed by the user, the character string input by the user, and the like. The content information DB 312 is a database that holds content information acquired from an external apparatus (such as an external server and a connected mobile terminal) and the like.

Relationship of Superordinate and Subordinate Concepts

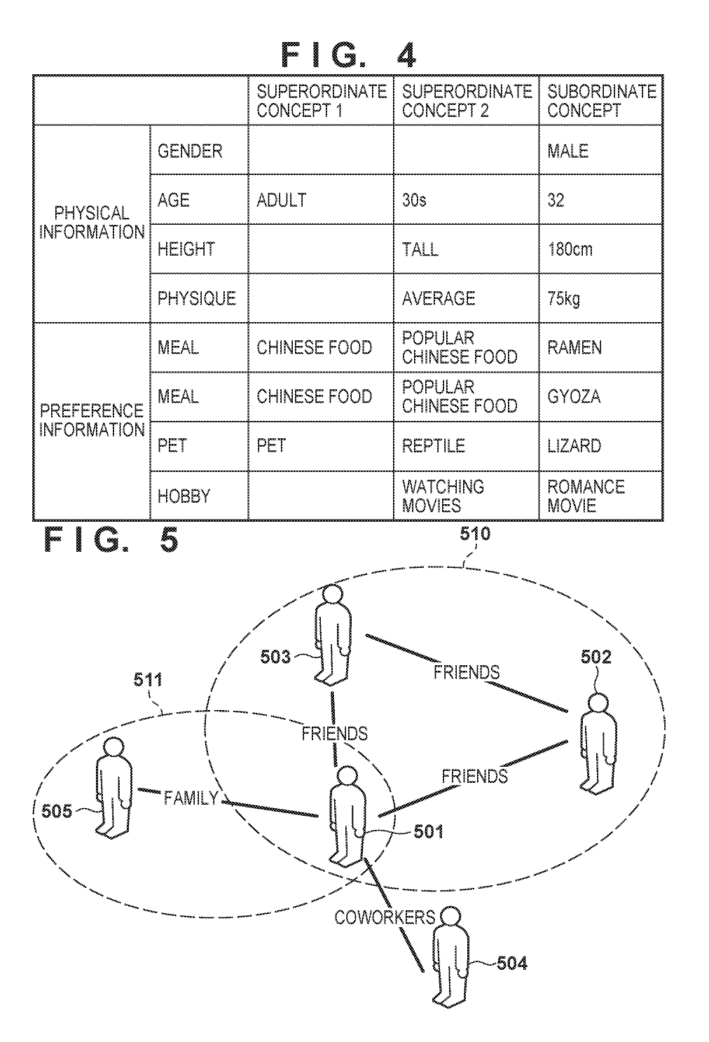

FIG. 4 is a drawing for describing the relationship of superordinate and subordinate concepts according to the present embodiment. The superordination and subordination described here is a relative relationship, not an absolute relationship. In addition, the superordination and subordination may not have a tree structure, and may have a graph structure, for example. In addition, one concept may have a plurality of superordinate concepts.

Here, “physical information” and “preference information” are described as examples of rough classification of information used for a user. The physical information is information representing a physical feature of a person. The value of the physical information may be acquired also from the detection apparatus 208 and the like for a person present in the space 1, for example. The preference information is information representing a feature of preferences of a person. The value of the preference information may be acquired from the user's operation history, information input so far, and the like, for example.

It is assumed that the physical information includes, in its subcategory, gender, age, height, and physique. Then, as a value in the age, attention is paid to “32-year-olds”. In this case, a concept “30s” is defined as a superordinate concept of “32-year-olds”. Further, a concept “adult” is defined as a superordinate concept of “30s”. Likewise, the preference information includes, as its subcategory, meal, pet, and hobby. Then, as a value in the meal, attention is paid to “ramen noodle soup”. In this case, a concept “popular Chinese food” is defined as a superordinate concept of “ramen noodle soup”. Further, a concept “Chinese food” is defined as a superordinate concept of “popular Chinese food”. That is, the concept according to the present embodiment is configured in a plurality of levels. The number of the levels are not limited and may be changed in accordance with the concept.

Such a relationship of superordination and subordination may be, but not limited to, defined by using a thesaurus dictionary, a knowledge graph, a statistical data, and the like. In addition, the relationship of superordinate and subordinate concepts may be defined based on the relationship of the terms used in information retrieval.

Relationship Between Persons

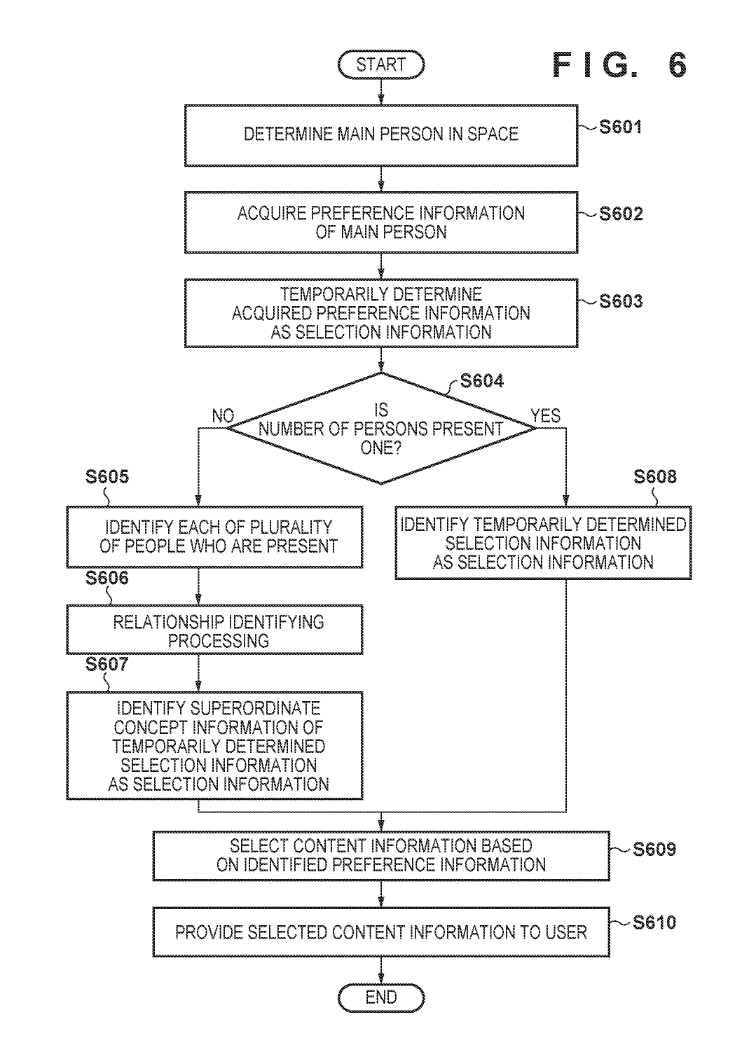

FIG. 5 is a drawing for describing a relationship between persons according to the present embodiment. FIG. 5 illustrates five persons, 501 to 505, and here, the person 501 is mainly described for describing the relationship. Note that only a single one-to-one relationship between persons is described here to simplify the description. Accordingly, a one-to-one relationship between persons may include a plurality of relationships (e.g. a case that they are “family” and “coworker”). In addition, the definition of the relationship described here is merely an example and is not limited to the example.

In FIG. 5, the relationship between the person 501 and the person 505 is “family”. The relationship of the person 501 with the person 502 and person 503 is “friend”. Also, the relationship between the person 502 and the person 503 is “friend”. The relationship between the person 501 and the person 504 is “coworker”.

In the present embodiment, for example, content information is provided based on a concept level that differs among a case that only the person 501 is present, a case that a plurality of persons are present in a range 510, and a case that a plurality of persons are present in a range 511, in a certain space.

Note that the user may be configured to register the relationship between the persons for each person as user information. Alternatively, the relationship may be configured to be estimated based on the frequency of simultaneous presence in the space (use history) and the like. Alternatively, the user may be configured to designate information (e.g. “family”) representing the relationship between a plurality of persons present in the space during occupying the space (e.g. a vehicle). That is, the method for estimating the relationship between the persons present in the space is not limited.

Process Flow

FIG. 6 is a flowchart of a process of the information provision apparatus 4 according to the present embodiment. This process is achieved when the CPU 201 of the information provision apparatus 4 reads and executes the program held in the ROM 203 and the like. This process is started in response to a request from a user present in the space, for example.

At S601, the CPU 201 determines a main person from among persons present in the space. For example, on the basis of information detected by the detection unit 208, when only one person is present, the person may be set as the main person. The main person may be a person who has connected the carrying mobile terminal to the information provision apparatus 4 as in FIG. 1, or a person in the driver's seat or the like in a case of a space in which seats are fixed as in a vehicle interior. Alternatively, the main person may be determined from among registered users by comparing information detected by the detection unit 208 and information registered in the user information DB 308 on the basis of a predetermined criterion.

At S602, the CPU 201 acquires preference information of the person determined at S601 by referring to the preference information DB 311. For example, in the example illustrated in FIG. 4, “meal” is selected as preference information. At this time, regarding the selection method, the selection may be made from the registered preference information on the basis of a predetermined condition or may be made by receiving designation from the user.

At S603, the CPU 201 temporarily determines the preference information acquired at S602 as selection information that is used in selection of content information.

At S604, the CPU 201 determines whether the number of persons present in the space is one. The information used for this determination is information acquired by the detection unit 208. According to a determination that a plurality of persons are present (NO at S604), the process proceeds to S605, yet when it is determined that only one person is present (i.e. only a main person is present) (YES at S604), the process proceeds to S608.

At S605, the CPU 201 identifies each of the plurality of persons present in the space. Here, information about the persons is held in the user information DB 308, and each person is identified with the information about persons held in the user information DB 308. Note that when an unregistered (unidentifiable) person is present, such a person is handled as an unregistered person.

At S606, the CPU 201 identifies the relationship between the persons identified at S605. Here, regarding the main person identified at S601, the relationship with other persons is identified. At this time, the CPU 201 identifies one or more relationships as the relationship between the main person and other persons. Note that in a case that an unregistered person is present, the relationship with the unregistered person may be handled as “unknown”. Alternatively, in a case that the user has input the relationship of the user present in the space, the relationship may be identified in accordance with that information.

At S607, the CPU 201 determines the level of the concept of the preference information for use in selection of the content information. The concept level determined here is defined in accordance with the relationship between the persons present in the space. In addition, in a case that several types of relationships are identified as the relationship between the persons present in the same space, the most superordinate concept of each relationship in the defined relationship of superordination and subordination is used. For example, it is assumed that “family” and “friend” are identified as the relationship between a plurality of persons present in the same space. In addition, it is assumed that a definition is used in which, in the example in FIG. 4, the concept (an attribute value) of “subordinate concept” is used in the space where only “family” is present, and the concept (an attribute value) of “superordinate concept 2” is used in the space where only “friend” is present. In this case, when “family” and “friend” are identified as the relationship between a plurality of persons present in the same space, the concept of “superordinate concept 2” is set to be used. The value according to the concept level determined here is identified as the selection information. That is, information of a superordinate concept of the selection information temporarily determined at S603 is used as the selection information. Then, the process proceeds to S609.

At S608, the CPU 201 identifies the selection information temporarily determined at S603 as the selection information for selecting the content information. Then, the process proceeds to S609.

At S609, the CPU 201 selects content information to be provided from the content information DB 312 by using the selection information identified at S607 or S608.

At S610, the CPU 201 provides the selected content information to the person present in the space. The information may be configured to be provided here by shown on a display device such as a display, or by outputting sound. Then, this process flow is terminated.

According to the present embodiment, with the above-mentioned configuration, information can be appropriately provided by selecting information to be provided in accordance with the relationship between a plurality of persons who receive the information. With this configuration, information specifying preference of a certain person is provided in a superordinate (abstract) level to a plurality of persons, and thus leakage of personal preferences can be prevented.

### Other Embodiments

While the process is performed by an information provision apparatus mounted in a vehicle in the embodiment, this is not limited to the embodiment. For example, the process of FIG. 3 may be configured to be performed on the server side in part or in its entirety.

In addition, in the embodiment, the content information is held in the content information DB 312, and the content information to be provided is selected from the content information held in the content information DB 312. However, this configuration is not limited thereto, and for example, the content information to be provided may be configured to be retrieved from an external database by using an external retrieval means (not illustrated in the drawing) on the basis of the classification of the information and the attribute value of the determined concept level.

### SUMMARY OF THE EXEMPLARY EMBODIMENT

1. An information provision system (e.g. 4, 300) of the embodiment is provided with a provision unit (e.g. 206, 307) capable of providing information to a plurality of persons in a perceptible manner, the information provision system including:

a selection unit (e.g. 305) configured to select the information provided by the provision unit by using selection information associated with a person to be provided with the information;

and a determination unit (e.g. 302) configured to determine whether the information provided by the provision unit is perceived by the plurality of persons.

According to a determination, by the determination unit, that the plurality of persons perceive the information provided by the provision unit, the selection unit selects the information provided by the provision unit by using, as the selection information, information of a superordinate concept of the selection information that is used when it is determined that the plurality of persons do not perceive the information provided by the provision unit.

According to the present embodiment, information can be appropriately provided by selecting information to be provided in accordance with the presence of a plurality of persons who receive the information.

2. In the information provision system of the embodiment,

the selection information includes preference information about a preference of a person; and

a relationship of superordinate and subordinate concepts is defined for the preference information.

According to the present embodiment, information specifying a preference of a certain person is provided in a superordinate (abstract) level to a plurality of persons, and thus leakage of personal preferences can be prevented.

3. In the information provision system of the embodiment,

the selection information includes physical information representing a physical feature of a person; and

a relationship of superordinate and subordinate concepts is defined for the physical information.

According to the present embodiment, information specifying physical information of a certain person is provided in a superordinate (abstract) level to a plurality of persons, and thus leakage of personal physical information can be prevented.

4. In the information provision system of the embodiment,

the relationship of superordinate and subordinate concepts is configured with a plurality of levels.

According to the present embodiment, an appropriate concept can be selected from among concepts defined in a plurality of levels and information can be provided based on the selected concept.

5. In the information provision system of the embodiment,

the relationship of superordinate and subordinate concepts is defined by a knowledge graph or a thesaurus dictionary.

According to the present embodiment, the relationship of superordinate and subordinate concepts can be appropriately defined.

6. The information provision system of the embodiment further includes

an identification unit (e.g. 303) configured to identify a relationship between the plurality of persons according to a determination, by the determination unit, that the plurality of persons perceive the information provided by the provision unit.

On a basis of the relationship identified by the identification unit, the selection unit determines a level of a concept to be used from among a plurality of levels in the superordinate and subordinate concepts.

According to the present embodiment, the concept for use in selection of the content information can be appropriately selected in accordance with the relationship between a plurality of persons.

7. The information provision system of the embodiment further includes

a detection unit (e.g. 208) configured to detect feature information of a person who perceives the information provided by the provision unit;

a holding unit (e.g. 308) configured to hold feature information of a person; and

a unit (e.g. 302) configured to identify the person by using the feature information detected by the detection unit and the feature information held by the holding unit.

According to the present embodiment, persons present in the space can be identified, and the relationship between the persons can be appropriately identified.

8. In the information provision system of the embodiment,

the plurality of persons are a plurality of persons who are present in a space of an interior of a vehicle.

According to the present embodiment, the information can be appropriately provided in the interior of a vehicle.

9. An information provision method of the embodiment uses a provision unit capable of providing information to a plurality of persons in a perceptible manner, the method including:

selecting the information provided by the provision unit by using selection information associated with a person to be provided with the information; and

determining whether the information provided by the provision unit is perceived by the plurality of persons, wherein

the selecting includes, according to a determination, in the determining, that the plurality of persons perceive the information provided by the provision unit the information provided by the provision unit, selecting by using, as the selection information, information of a superordinate concept of the selection information that is used when it is determined that the plurality of persons do not perceive the information provided by the provision unit.

According to the present embodiment, information can be appropriately provided by selecting information to be provided in accordance with the presence of a plurality of persons who receive the information.

10. A non-transitory computer-readable medium of the embodiment stores a program for causing a computer (e.g. 200) to function as

a selection unit (e.g. 305) configured to select information provided by a provision unit (e.g. 206, 307) by using selection information associated with a person to be provided with the information, the provision unit being capable of providing the information to a plurality of persons in a perceptible manner; and

a determination unit (e.g. 302) configured to determine whether the information provided by the provision unit is perceived by the plurality of persons.

According to a determination, by the determination unit, that the plurality of persons perceive the information provided by the provision unit, the selection unit selects the information provided by the provision unit by using, as selection information, information of a superordinate concept of the selection information that is used when it is determined that the plurality of persons do not perceive the information provided by the provision unit.

According to the present embodiment, information can be appropriately provided by selecting information to be provided in accordance with the presence of a plurality of persons who receive the information.

What is claimed is:

1. An information provision system with a provision unit capable of providing information to a plurality of persons in a perceptible manner, the information provision system comprising:
a selection unit configured to select the information provided by the provision unit by using selection information associated with a person to be provided with the information; and
a determination unit configured to determine whether the information provided by the provision unit is perceived by the plurality of persons, wherein
according to a determination, by the determination unit, that the plurality of persons perceive the information provided by the provision unit, the selection unit selects the information provided by the provision unit by using, as the selection information, information of a superordinate concept of the selection information that is used when it is determined that the plurality of persons do not perceive the information provided by the provision unit.

2. The information provision system according to claim 1, wherein
the selection information includes preference information about a preference of a person; and
a relationship of superordinate and subordinate concepts is defined for the preference information.

3. The information provision system according to claim 1, wherein
the selection information includes physical information representing a physical feature of a person; and
a relationship of superordinate and subordinate concepts is defined for the physical information.

4. The information provision system according to claim 2, wherein the relationship of superordinate and subordinate concepts is configured with a plurality of levels.

5. The information provision system according to claim 2, wherein the relationship of superordinate and subordinate concepts is defined by a knowledge graph or a thesaurus dictionary.

6. The information provision system according to claim 5, further comprising an identification unit configured to identify a relationship between the plurality of persons according to a determination, by the determination unit, that the plurality of persons perceive the information provided by the provision unit, wherein
on a basis of the relationship identified by the identification unit, the selection unit determines a level of a concept to be used from among a plurality of levels in the superordinate and subordinate concepts.

7. The information provision system according to claim 1, further comprising:
a detection unit configured to detect feature information of a person who perceives the information provided by the provision unit;
a holding unit configured to hold feature information of a person; and
a unit configured to identify the person by using the feature information detected by the detection unit and the feature information held by the holding unit.

8. The information provision system according to claim 1, wherein
the plurality of persons are a plurality of persons who are present in a space of an interior of a vehicle.

9. An information provision method using a provision unit capable of providing information to a plurality of persons in a perceptible manner, the method comprising:
selecting the information provided by the provision unit by using selection information associated with a person to be provided with the information; and
determining whether the information provided by the provision unit is perceived by the plurality of persons, wherein
the selecting includes, according to a determination, in the determining, that the plurality of persons perceive the information provided by the provision unit, selecting the information provided by the provision unit by using, as the selection information, information of a superordinate concept of the selection information that is used when it is determined that the plurality of persons do not perceive the information provided by the provision unit.

10. A non-transitory computer-readable medium storing a program for causing a computer to function as
a selection unit configured to select information provided by a provision unit by using selection information associated with a person to be provided with the information, the provision unit being capable of providing the information to a plurality of persons in a perceptible manner; and
a determination unit configured to determine whether the information provided by the provision unit is perceived by the plurality of persons, wherein
according to a determination, by the determination unit, that the plurality of persons perceive the information provided by the provision unit, the selection unit selects the information provided by the provision unit by using, as selection information, information of a superordinate concept of the selection information that is used when it is determined that the plurality of persons do not perceive the information provided by the provision unit.
